(19) United States
(12) Patent Application Publication
(10) Pub. No.: US 2018/0068347 A1
(43) Pub. Date: Mar. 8, 2018

(54) GENERATING A BROWSING AREA OF A WEB BROWSER

(71) Applicants: Roshan Fernandes, Mountain View, CA (US); Bindu Oommen Fernandes, Mountain View, CA (US)

(72) Inventors: Roshan Fernandes, Mountain View, CA (US); Bindu Oommen Fernandes, Mountain View, CA (US)

(21) Appl. No.: 13/711,363

(22) Filed: Dec. 11, 2012

(51) Int. Cl. G06Q 30/02; G06F 3/048

(52) U.S. Cl. CPC G06Q 30/0255; G06F 3/048

(57) ABSTRACT

Systems and methods for generating a browsing area of a web browser include receiving a request for a new browsing area and allocating a portion of the new browsing area for a function. The function may populate the allocated portion of the new browsing area with retrieved content.

### BACKGROUND

Websites and other online sources may provide content to client devices relating to any number of different topics. For example, a first website may be devoted the latest golf equipment and a second website may be devoted to automobiles. Users having an interest in a particular topic may navigate to an online content source providing content related to that topic. In some cases, a user may utilize a search engine to find online content. For example, a user may search the Internet for reviews of the latest golf equipment and the search engine may return a listing of websites devoted to reviews of golf equipment. The user may navigate between the various websites in the listing to view the various websites.

### SUMMARY

Implementations of the systems and methods for generating a browsing area in a web browser are described herein. One implementation is a computerized method for generating a browsing area of a web browser. The method includes receiving, at a processing circuit, a request for a new browsing area of the web browser. The method also includes allocating, by the processing circuit, a portion of the new browsing area for a function. The method further includes retrieving, via a network interface, content selected by a content selection engine for the function, in response to receiving the request for a new browsing area. The method yet further includes populating the allocated portion of the new browsing area with the retrieved selected content.

Another implementation is a system for generating a browsing area of a web browser. The system includes a processing circuit operable to receive a request for a new browsing area of the web browser. The processing circuit is also operable to allocate a portion of the new browsing area for a function. The processing circuit is further operable to retrieve, via a network interface, content selected by a content selection engine for the function, in response to receiving the request for a new browsing area. The processing circuit is yet further operable to populate the allocated portion of the new browsing area with the retrieved selected content.

A further implementation is a tangible computer-readable storage medium having instructions therein, the instructions being executable by a processor to cause the processor to perform operations. The operations include receiving a request for a new browsing area of the web browser. The operations also include allocating a portion of the new browsing area for a function. The operations further include retrieving, via a network interface, content selected by a content selection engine for the function, in response to receiving the request for a new browsing area. The operations also include populating the allocated portion of the new browsing area with the retrieved selected content.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an electronic display showing an example web browser;

FIG. 3 is an example illustration of a new browsing area being generated by a web browser;

FIG. 4 is an example illustration of content being included in a new browsing area of a web browser; and

FIG. 5 is an example process for generating a new browsing area of a web browser.

Like reference numbers and designations in the various drawings indicate like elements.

### DETAILED DESCRIPTION

According to aspects of the present disclosure, an electronic device may access content remotely via a network. For example, a personal computer may be used to retrieve a webpage from a content source via the Internet. In various implementations, an electronic device may execute a web browser application configured to request the content and to display retrieved content. For example, a user of the electronic device may navigate to a particular webpage by specifying a uniform resource locator (URL) to the web browser. The web browser may then request and retrieve webpage data from the network location that corresponds to the URL.

In various implementations, a web browser may be configured to utilize a plurality of browsing areas. In general, a browsing area refers to an area of a displayed web browser in which retrieved content may be displayed. For example, a web browser may display a retrieved webpage within a particular window and/or tab of the web browser. Multiple browsing areas allow for content from disparate sources to remain active within the web browser at the same time. In some cases, two or more browsing areas may be displayed at the same time. In other cases, a user may switch between browsing areas to quickly display different content. For example, a first webpage may be opened in a first tab and a second webpage may be opened in a second tab. In such a case, a user may alternate between tabs to view the first or second webpage.

A web browser may be configured to open and/or close browsing areas in response to receiving input from an interface device, according to various implementations. For example, a user may operate a mouse, keyboard, touchscreen display, or other form of interface device to request that a new window or tab be opened by the web browser. In some implementations, a new browsing area may be blank (e.g., displaying only whitespace) when the browsing area is first generated. In other implementations, at least a portion of a new browsing area may be allocated for additional functions and/or content. For example, a newly opened window in a web browser may display suggested content for a user (e.g., a link to a website frequently visited by the user, a retrieved advertisement, etc.).

For situations in which the systems discussed herein collect personal information about a user, or may make use of personal information, the user may be provided with an opportunity to control which programs or features collect such information, the types of information that may be collected (e.g., information about a user's social network, social actions or activities, a user's preferences, a user's current location, etc.), and/or how third-party content may be selected by a content selection service and presented to the user. Certain data, such as a device identifier, may be anonymized in one or more ways before it is stored or used, so that personally identifiable information is removed when generating parameters (e.g., demographic parameters) used by the content selection service to select third-party content. For example, a device identifier may be anonymized so that no personally identifiable information about its corresponding user can be determined from it. In another example, a user's geographic location may be generalized where location information is obtained (such as to a city, ZIP code, or state level), so that a precise location of the user cannot be determined. Thus, the user may have control over how information is collected about him or her and used by the content selection service.

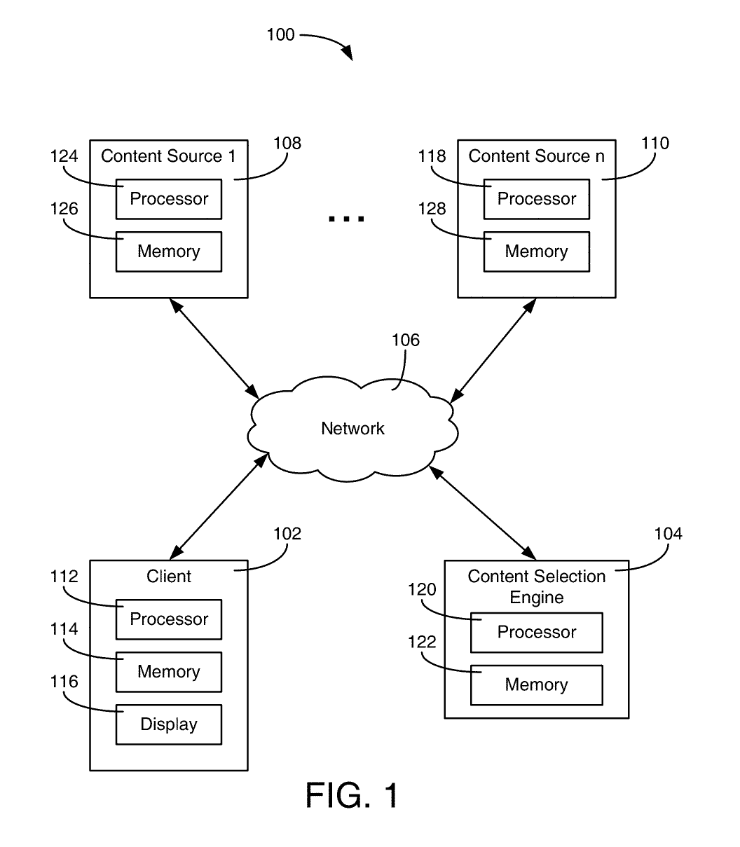

Referring to FIG. 1, a block diagram of a computer system 100 in accordance with a described implementation is shown. System 100 includes a client 102 which communicates with other computing devices via a network 106. Client 102 may execute a web browser or other application (e.g., a video game, a messaging program, etc.) to retrieve content from other devices over network 106. For example, client 102 may communicate with any number of content sources 108, 110 (e.g., a first content source through nth content source), which provide electronic content to client 102, such as webpage data and/or other content (e.g., text documents, PDF files, and other forms of electronic documents). In some implementations, computer system 100 may also include a content selection engine 104 configured to select content to be provided to client 102. For example, content selection engine 104 may select which content from content sources 108, 110 is sent to client 102. In another example, content selection engine 104 may itself provide selected content to client 102.

Network 106 may be any form of computer network that relays information between client 102, content sources 108, 110, and content selection engine 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other forms of content received from content sources 108, 110 and/or content selection engine 104.

Content sources 108, 110 may be one or more electronic devices connected to network 106 that provide content to client 102. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, an image file, and other forms of electronic documents. Similar to client 102, content sources 108, 110 may include processing circuits that include processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

Content selection engine 104 may be one or more electronic devices connected to network 106 and configured to select content to be provided to client 102. Content selection engine 104 may be a computer server (e.g., an FTP server, file sharing server, web server, etc.) or a combination of servers (e.g., a data center, a cloud computing platform, etc.). Content selection engine 104 may include a processing circuit including a processor 120 and a memory 122 that stores program instructions executable by processor 120. In cases in which content selection engine 104 is a combination of computing devices, processor 120 may represent the collective processors of the devices and memory 122 may represent the collective memories of the devices. In other implementations, the functionality of content selection engine 104 may be integrated into content sources 108, 110 or other devices connected to network 106.

In some implementations, a user of client 102 may elect to allow content selection engine 104 to identify and store data relating to client 102 and the user. For example, the user may elect to receive content selected by content selection engine 104 that may be more relevant to him or her. In one implementation, a device identifier for client 102 may be randomized and contain no personally-identifiable information about the user of client 102. Thus, the user of client 102 may have control over how information is collected and used by content selection engine 104, in various implementations.

If the user of client 102 elects to receive relevant content, content selection engine 104 may store a device identifier to represent client 102. A device identifier may be associated with one or more other device identifiers, in some implementations. For example, a device identifier associated with client 102 may also be associated with a device identifier for the user's mobile phone. Such an association may be made, for example, by the user of client 102 logging into the same online account or profile from different devices, according to some implementations. In various implementations, a device identifier may be, but is not limited to, a cookie, a network address, an email address, a screen name or other alias, a hardware-based identifier (e.g., an identifier based on the device's MAC address, etc.), or a universally unique identifier (UUID).

Content selection engine 104 may select relevant content (e.g., an advertisement or other form of online content) based on a device identifier. In some implementations, content selection engine 104 may store history data indicative of webpages visited by client 102 and analyze the content of the webpages to identify themes in which the user may be interested. For example, client 102 may be used to access a number of webpages devoted to golf. In such a case, an interest category of golf may be assigned to a device identifier associated with client 102. Golf-related content may then be selected by content selection engine 104 to enhance the browsing experience of the user. In some implementations, content selection engine 104 may conduct a content auction to allow different content sources to compete to provide relevant content to client 102. For example, online retailers of golf equipment may compete in a content auction to provide an advertisement to client 102, if an interest category of golf is assigned to the device identifier associated with client 102. In further implementations, the content auction may be a placement auction for a particular content space displayed by a web browser (e.g., banner area along the top of the web browser, a space displayed along the side of the web browser, an area of a new window of the web browser, etc.).

Relevant content may be provided to client 102 by content sources 108, 110 or content selection engine 104. For example, content selection engine 104 may select relevant content from content source 110 to be included with a webpage served by content source 108. In another example, content selection engine 104 may provide the selected content directly to client 102. In some implementations, content selection engine 104 may select content stored in memory 114 of client 102. For example, previously provided content from a content source may be stored in memory 114, content may be loaded into memory 114 (e.g., as part of the installation of an application), or may exist as part of the operating system of client 102. In such cases, content selection engine 104 may provide an indication of the selection to client 102. In response, client 102 may retrieve the selected content from memory 114 and display it on electronic display 116.

In various implementations, a web browser on client 102 may be configured to generate a browsing area in response to receiving input from an interface device of client 102. For example, the web browser may generate a browsing area when the web browser is opened, a new tab is requested, or a new window is requested. In some implementations, a newly generated browsing area may include links to suggested content based on history data stored in memory 114. For example, links to the most frequently visited websites by client 102 may be displayed in a newly generated browsing area based on browsing history stored in memory 114. In further implementations, client 102 may request content from content selection engine 104 in response to receiving a request for a new browsing area. In such a case, content selection engine 104 may select content, such as an advertisement, to be displayed in the newly generated browsing area.

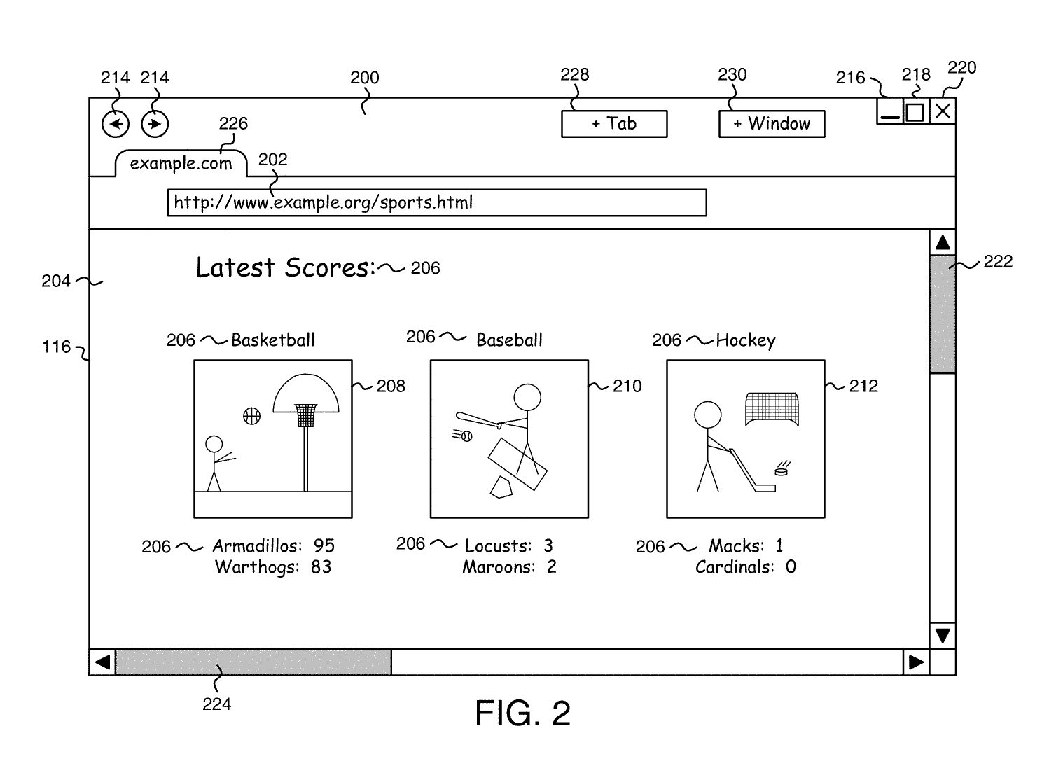

Referring now to FIG. 2, an illustration is shown of electronic display 116 displaying an example web browser 200. Web browser 200 may be displayed on electronic display 116 in response to processor 112 executing instructions stored in memory 114. In various implementations, electronic display 116 may be located inside or outside of the same housing as that of processor 112 and/or memory 114. For example, electronic display 116 may be an external display, such as a computer monitor, television set, or any other stand-alone form of electronic display. In other examples, electronic display 116 may be integrated into the housing of a laptop computer, mobile device, or other form of computing device having an integrated display.

As shown, web browser 200 may include an input field 202 configured to receive a network address. A network address may be a URL, Internet Protocol (IP) address, file transfer protocol (FTP) address, or other similar form of data that identifies a device located on a network. For example, the URL http://www.example.com/sports.html may be entered into input field 202. In another example, http://192.0.43.10/sports.html may be entered instead to use the IP address of the content source that serves the website for www.example.com. Web browser 200 may send a request for content to the network address specified in input field 202. For example, web browser 200 may request webpage data from www.example.com, such as the file, sports.html. In general, webpage data may include text, hyperlinks, layout information, and other data that may be used to provide the framework for the visual layout of a webpage by web browser 200.

Web browser 200 may include browsing area 204 in which retrieved content may be displayed on electronic display 116. In some implementations, retrieved webpage data may be one or more files of webpage code written in a markup language, such as the hypertext markup language (HTML), extensible HTML (XHTML), extensible markup language (XML), or any other markup language. The webpage data may include data that specifies where indicia appear in browsing area 204, such as text 206. In other words, web browser 200 may process the webpage data to render the webpage in browsing area 204. In some implementations, webpage data may include links to additional data and/or scripts that cause web browser 200 to retrieve additional content. For example, the file, “sports.html,” may include one or more instructions used by processor 112 to retrieve images 208-212 from their respective content sources.

Web browser 200 may include a number of controls associated with navigating between webpages. For example, web browser 200 may include the ability to go back or forward to other webpages using inputs 214 (e.g., a back button, a forward button, etc.). Web browser 200 may also include inputs to control the processing of a webpage (e.g., a stop button, a refresh button, a zoom button, etc.). In some implementations, web browser 200 may include one or more scroll bars 222, 224, which can be used to display parts of display area 204 that are currently not being displayed by electronic display 116 (e.g., parts of a webpage that are currently off-screen). For example, a webpage may be formatted to be larger than the screen of electronic display 116. In such a case, scroll bars 222, 224 may be used to change the vertical and/or horizontal position of the webpage on electronic display 116.

Web browser 200 may include various inputs configured to control the display of web browser 200 on electronic display 116. In some cases, web browser 200 may include an input 216 configured to cause web browser 200 to be minimized on electronic display 116. Selection of input 216, for example, may cause other applications, file system windows, and/or a desktop of an operating system to be displayed on electronic display 116. Web browser 200 may include an input 218 configured to cause web browser 200 to be maximized on electronic display 116. Selection of input 218 may cause only web browser 200 to be displayed (e.g., other applications, folders, desktops, etc., may be hidden from view). Web browser 200 may also include an input 220 configured to cause the window of web browser 200 to be closed.

According to various implementations, web browser 200 may be configured to generate a new browsing area in response to receiving a request for a new browsing area. In some implementations, web browser 200 may generate a new browsing area within a new window, in response to receiving a selection of an input 230 or via selection of a keypad hotkey. In further implementations, web browser 200 may generate a new browsing area within a new tab in response to receiving a selection of a keypad hotkey or an input 228. In general, a new window differs from a new tab in that navigational controls are duplicated for a new window. For example, selection of input 230 may cause web browser 200 to generate a new window that includes duplicates of inputs 214, scroll bars 222, 224, etc. In contrast, selection of input 228 may cause a new tab to be displayed adjacent to a tab 226 in which browsing area 204 is displayed. In such a case, the new tab may utilize the same controls as that of tab 226, such as inputs 214, 216, 218, 220, etc.

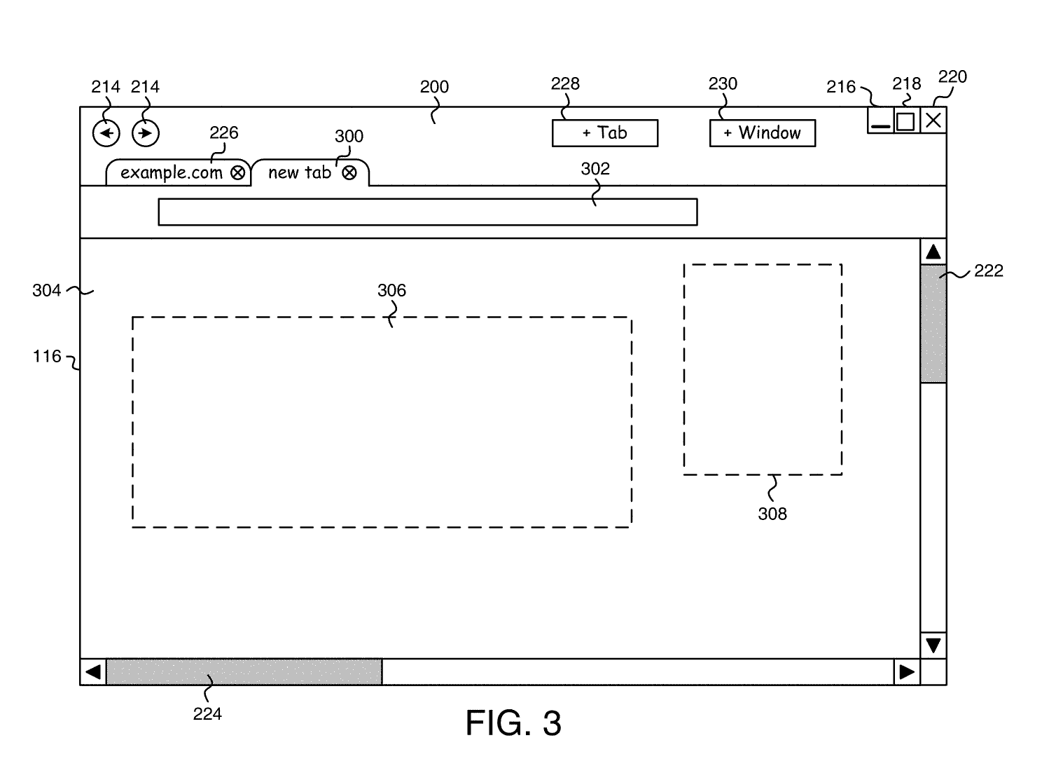

Referring now to FIG. 3, an example illustration of a new browsing area being generated by web browser 200 is shown. In various implementations, browsing area 304 may be generated as part of a new tab 300 by web browser 200. For example, web browser 200 may create tab 300 in response to receiving a selection of input 228. Having multiple tabs open in web browser 200 may allow for multiple browsing sessions to be active at the same time. For example, tab 226 may retain the browsing session for browsing area 204 (e.g., the webpage located at http://www.example.com/sports.html). Similarly, a second webpage may be retrieved via input of a network address into an input field 302 associated with tab 300. The second webpage may then be displayed in display area 304. If multiple tabs are open in web browser 200, selection of a tab (e.g., tab 226, tab 300, etc.) may cause its respective browsing area to be displayed on electronic display 116.

In some implementations, browsing area 304 may be blank when it is generated by web browser 200. For example, browsing area 304 may appear as a solid color (e.g., white or another color) or display a background graphic, when tab 300 is created by web browser 200. In further implementations, a webpage may be automatically (i.e., without further interaction from a user) retrieved and displayed in browsing area 304 when tab 300 is created. For example, web browser 200 may include a parameter that specifies a default webpage to be retrieved and displayed when a new tab and/or window is opened. In another example, a browsing session may be duplicated in a newly opened tab or window (e.g., the webpage being displayed in tab 226 may be automatically loaded in browsing area 304 when tab 300 is opened).

According to various implementations, at least a portion of browsing area 304 may be allocated for a particular function of web browser 200 when browsing area 304 is generated. The function may be within the code for web browser 200, may be a plug-in for web browser 200, may be a script or other form of code executed by web browser 200, or may be a stand-alone application executed by web browser 200. For example, a first area 306 may be allocated for a first function and a second area 308 may be allocated for a second function. Rather than displaying a generic background or returning a particular webpage when tab 300 is opened, areas 306, 308 may be populated with indicia from their corresponding functions. In some implementations, a portion of browsing area 304 may be populated with cached content (i.e., content already stored in memory 114 of client 102), content retrieved via a network, a video game, a chat application, one or more bookmarks (e.g., one or more links to webpages stored as parameters for web browser 200), a media file (e.g., a sound file, a video file, etc.), or the like. In further implementations, a portion of browsing area 304 may be populated with suggested content, if the user of web browser 200 elects to receive suggested content.

Web browser 200 may be configured to utilize one or more parameters to control which function populates a particular portion of browsing area 304. In some implementations, the user of web browser 200 may manually set a parameter. For example, the user of web browser 200 may select to view a chat program whenever a new browsing area is opened by web browser 200. In other implementations, a function for browsing area 304 may be selected automatically (i.e., without further input from a user). For example, a user of web browser 200 may elect to receive suggestions and may frequently check an email account. In such a case, web browser 200 may populate an area of a newly opened browsing area with an email function based on the user's frequent checking of the email account. Thus, the type of function used to populate a portion of a newly opened browsing area may be selected based on its relevance to the user of web browser 200.

In some implementations, a user may elect to receive relevant content in a newly opened browsing area of web browser 200. For example, area 306 may be populated with a link to a webpage that has not been previously visited by web browser 200. Such a link may be suggested by web browser 200 based on themes of previously visited webpages. For example, assume that web browser 200 is used to visit a number of webpages devoted to hang gliding. Web browser 200 may then present a link in a newly opened browsing area to a different webpage that is also devoted to hang gliding. In another example, a newly opened browsing area of web browser 200 may be populated with an advertisement for a sale that may be of interest to the user of web browser 200. In some implementations, web browser 200 may request suggested content from a remote device via a network, such as content selection engine 104. In such a case, content selection engine 104 may analyze webpages or other online actions for a device identifier associated with the request and select the relevant content. Thus, content used to populate a portion of a newly opened browsing area may also be selected based on its potential relevance to a user of web browser 200. In other implementations, content may be selected for a newly opened browsing area of web browser 200 randomly and/or without regard to interest categories associated with a device identifier.

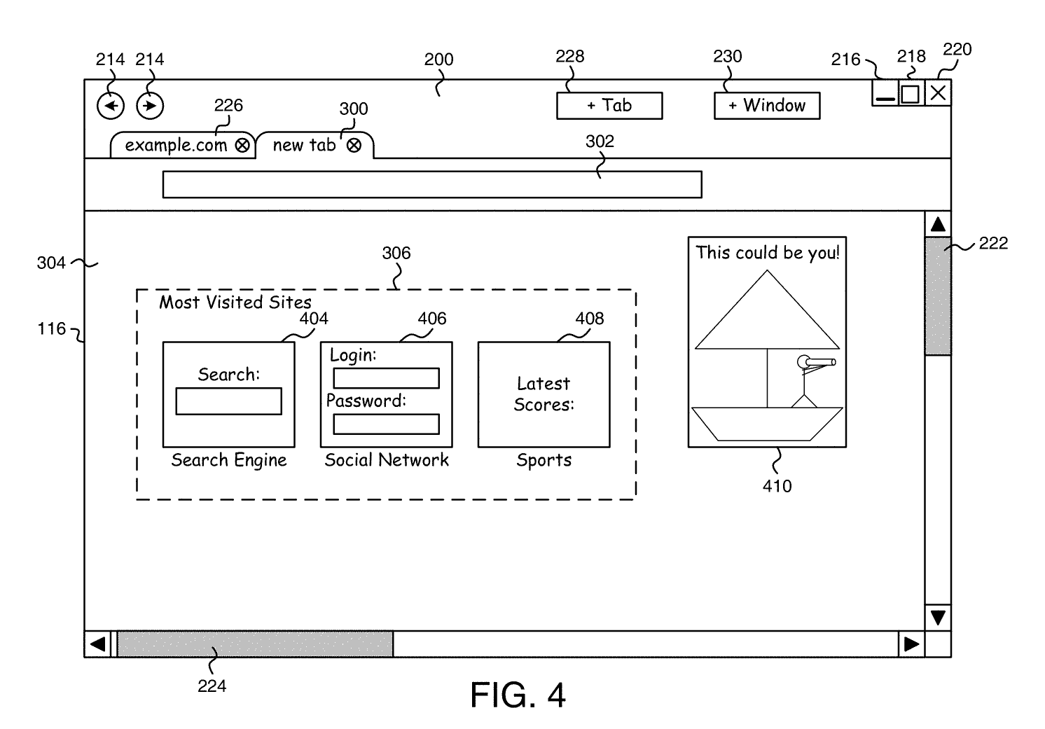

Referring now to FIG. 4, an example illustration of content being included in a new browsing area of web browser 200 is shown. In some implementations, a newly opened browsing area, such as browsing area 304, may be populated by one or more functions. As shown, assume that tab 300 has been opened recently via selection of input 228. In response to the selection of input 228, web browser 200 may generate browsing area 304 and allocate areas 306, 308 to various functions. The functions may then populate their respective areas of browsing area 304.

In one example, area 306 of browsing area 304 may be populated by a function that lists the most visited websites by web browser 200. For example, assume that the most frequently visited websites by web browser 200 include a search engine website, a social network website, and a website that provides the latest sports scores. In such a case, area 306 may be populated with a graphical interface 402 that includes links to the most visited websites. For example, interface 402 may include a first link 404 to the search engine website, a second link 406 to the social networking website, and a third link 408 to the sports-related website. Selection of any of links 404-408 may then cause the respective website to be loaded into browsing area 304. In some implementations, links 404-408 may be selected based on local history for web browser 200. For example, web browser 200 may store webpage data (e.g., images, HTML files, cookies, an index of webpage visits, etc.) in a local cache and retrieve at least a part of the webpage from local memory to reduce the loading time of the webpage. In other implementations, the user of web browser 200 may allow a remote device to store information about the online history of web browser 200. For example, the user of web browser 200 may allow a synchronization service and/or content selection engine 104 to store and use history data regarding the browsing history of web browser 200.

In another example, area 308 of browsing area 304 may be populated by a function that displays suggested content 410 (e.g., an advertisement for a boat). Content 410 may be static content (e.g., simply an image or text) or may include a hotlink (e.g., selection of content 410 redirects web browser 200 to a webpage). For purposes of this example, assume that the user of web browser 200 has elected to view suggested content in a newly created browsing area and/or to allowing browsing history data to be used to suggest relevant content. In some implementations, a request for suggested content may be sent from web browser 200 to content selection engine 104 in response to selection of input 228 (i.e., in response to receiving a request for a new browsing area). The request may include a device identifier used by content selection engine 104 to select relevant content based on the identifier. For example, content selection engine 104 may retrieve browsing history data stored by content selection engine 104 that is associated with the device identifier. Content selection engine 104 may analyze the browsing history data to identify one or more potential interests for the device identifier and select relevant content based on an identified interest. In other implementations, the request to content selection engine 104 may also include the browsing history data. For example, content selection engine 104 may select content 410 based on an identified interest category of sailing. In various implementations, content selection engine 104 may provide content 410 to web browser 200 or provide data to web browser 200 configured to cause web browser 200 to retrieve content 410 (e.g., from local memory or a networked content source).

A newly created browsing area may incorporate any number different functions and/or content, regardless of how the browsing area is presented by web browser 200. For example, while browsing area 304 is shown in FIG. 4 as being part of a newly opened tab 300, browsing area 304 may also be presented within a newly opened window. In some implementations, a tab or window may be configured to display multiple browsing areas. For example, tab 300 may include two or more browsing areas. Each browsing area may be configured to independently display content, in some cases. For example, a first browsing area may be used to review a first webpage and a second browsing area may be used to review a second webpage. When each browsing area is created, at least a portion of one or both browsing areas may be populated by a function. For example, a portion of a first browsing area may include a suggested advertisement selected based on its potential relevance to the user of web browser 200.

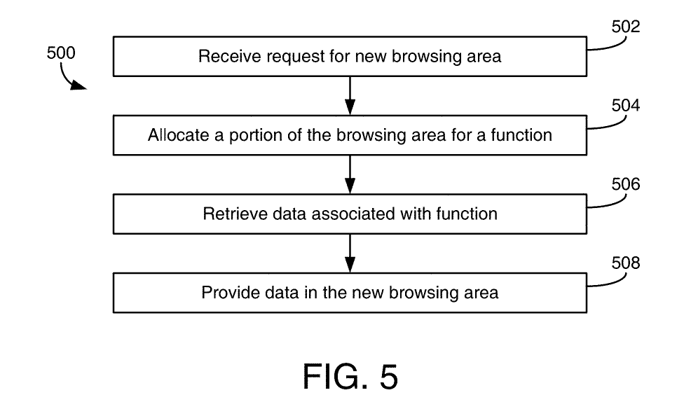

Referring now to FIG. 5, an example process 500 for generating a new browsing area of a web browser is shown. In various implementations, process 500 is performed by a computing device executing a web browser. In some implementations, process 500 may be used in conjunction with the selection of online content for a device identifier. For example, content may be selected for a device identifier based on one or more interest categories identified based on browsing history data for the device identifier.

Process 500 includes receiving a request for a new browsing area of a web browser (block 502). In some cases, a request may correspond to the selection of a button, menu, or other graphical input field of the web browser. In other cases, a request may correspond to a voice command, selection of a hotkey (e.g., CTRL+T, CTRL+N, etc.), or similar input from a user interface device. In various implementations, the request may correspond to a request to open a new tab, window, or other graphical area of the web browser. For example, a pointing device may be used to select a “New Tab” button of the web browser. In further implementations, the request may correspond to launching the web browser itself.

Process 500 includes allocating a portion of the browsing area for a function (block 504). In response to receiving a request for a new browsing area, a new browsing area may be generated having at least a portion of the area allocated for a function. In general, the function may be any program code that populates the allocated portion of the browsing area with one or more graphical objects. For example, the function may be a chat program, email program, bookmark utility, content selection function, etc. In some implementations, one or more parameters may be used by the web browser to control which function populates the allocated portion of the browsing area. For example, a user of the web browser may manually select the function or the web browser may automatically select the function based on previous use of the web browser.

Process 500 includes retrieving data associated with the function (block 506). In some implementations, data may be retrieved from a local memory. For example, a function that lists recently or frequently opened websites may retrieve data relating to the websites from a local memory of the device that executes the web browser. In some implementations, the function may retrieve data from a remote device. For example, a function that suggests content may request suggested content (e.g., the address of a webpage, an advertisement, etc.) from a content selection engine via a network. In some implementations, a parameter may affect which data is retrieved by a function. For example, a user of the web browser may elect to receive relevant content. In such a case, the content selection engine may analyze history data indicative of online actions performed by a device identifier (e.g., visiting a webpage, receiving content devoted to a particular theme, selecting an advertisement, making an online purchase, etc.) to determine one or more interest categories. An identified interest category for the device identifier may then be used to select the content returned to the function.

Process 500 includes providing the data in the new browsing area of the web browser (block 508). Data retrieved by a function associated with an allocated portion of a new browsing area may be displayed in the allocated portion. For example, opening a new tab or window of the web browser may cause suggested content, such as an advertisement, to be displayed in a portion of the newly created browsing area. In another example, an email function may display a list of email messages that are part of an inbox. In a further example, a chat function may display a list of users that are currently available to chat in the allocated portion of the new browsing area. In some implementations, multiple portions of a new browsing area may be populated with data from multiple functions.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A tangible computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A computerized method for generating a browsing area of a web browser comprising:
receiving, at a processing circuit of a client device executing a web browser, a local interaction requesting a new browsing area of the web browser, wherein the new browsing area is one of a new tab or new window of the web browser;
and responsive to receiving the request for the new browsing area:
creating, by the client device executing the web browser, the new browsing area comprising a first portion and a second portion;
identifying a sub-set of content locations comprising a pre-determined number of most frequently retrieved content locations from a set of content locations indicated in a browsing history of the web browser;
generating page data comprising elements selectable to retrieve content from the identified sub-set of content locations;
displaying a rendering of the generated page data in the first portion of the new browsing area, the rendering including the one or more selectable elements; and
populating the second portion of the new browsing area with additional content selected by a content selection engine by:
transmitting, via a network interface to the content selection engine, a content request including a device identifier,
receiving, via the network interface, additional content selected by the content selection engine by identifying, from browsing history stored by the content selection engine in association with the device identifier, the sub-set of content locations and selecting the additional content based on the identified sub-set of content locations, and
displaying, in the second portion of the new browsing area, the received additional content while displaying the one or more selectable elements in the first portion of the new browsing area.

2. (canceled)

3. The method of claim 1, wherein the additional content is selected by the content selection engine based on the device identifier.

4. The method of claim 1, wherein the additional content is selected based on an interest category determined from the browsing history.

5. The method of claim 1, wherein the additional content is selected via a content auction.

6. The method of claim 1, wherein the request for a new browsing area comprises a request to open the web browser.

7. (canceled)

8. A system for generating a browsing area of a web browser comprising a processing circuit of a client device executing the web browser, the processing circuit configured to:
receive a local interaction requesting a new browsing area of the web browser, wherein the new browsing area is one of a new tab or new window of the web browser; and
responsive to receiving the request for the new browsing area:
create the new browsing area comprising a first portion and a second portion;
identify a sub-set of content locations comprising a pre-determined number of most frequently retrieved content locations from a set of content locations indicated in a browsing history of the web browser;
generate page data comprising elements selectable to retrieve content from the identified sub-set of content locations;
display a rendering of the generated page data in the first portion of the new browsing area, the rendering including the one or more selectable elements; and
populate the second portion of the new browsing area with additional content selected by a content selection engine by:
transmitting, via a network interface and to the content selection engine, a content request including a device identifier;
receiving, via the network interface, additional content selected by the content selection engine by identifying, from browsing history stored by the content selection engine in association with the device identifier, the sub-set of content locations and selecting the additional content based on the identified sub-set of content locations; and
displaying, in the second portion of the new browsing area, the received additional content while displaying the one or more selectable elements in the first portion of the new browsing area.

9. (canceled)

10. The system of claim 8, wherein the additional content is selected by the content selection engine based in part on the device identifier.

11. The system of claim 8, wherein the additional content is selected based on an interest category determined from the browsing history.

12. The system of claim 8, wherein the additional content is selected via a content auction.

13. The system of claim 8, wherein the request for a new browsing area comprises a request to open the web browser.

14. (canceled)

15. A non-transitory tangible computer-readable medium storing instructions executable by a processor to cause the processor to:
receive a local interaction requesting a new browsing area of the web browser, wherein the new browsing area is one of a new tab or new window of the web browser; and
responsive to receiving the request for the new browsing area:
create the new browsing area comprising a first portion and a second portion,
identify a sub-set of content locations comprising a pre-determined number of most frequently retrieved content locations from a set of content locations indicated in a browsing history of the web browser,
generate page data comprising elements selectable to retrieve content from the identified sub-set of content locations,
display a rendering of the generated page data in the first portion of the new browsing area, the rendering including the one or more selectable elements, and
populate the second portion of the new browsing area with additional content selected by a content selection engine by:
transmitting, via a network interface to the content selection engine, a content request including a device identifier,
receiving, via the network interface, additional content selected by the content selection engine by identifying, from browsing history stored by the content selection engine in association with the device identifier, the sub-set of content locations and selecting the additional content based on the identified sub-set of content locations, and
displaying, in the second portion of the new browsing area, the received additional content while displaying the one or more selectable elements in the first portion of the new browsing area.

16. (canceled)

17. The non-transitory tangible computer-readable medium of claim 15, wherein the additional content is selected by the content selection engine based in part on the device identifier.

18. The non-transitory tangible computer-readable medium of claim 15, wherein the additional content is selected based on an interest category determined from the browsing history.

19. The non-transitory tangible computer-readable medium of claim 15, wherein the request for a new browsing area comprises a request to open the web browser.

20. The non-transitory tangible computer-readable medium of claim 15, wherein the one or more advertisements are selected via a content auction.

21. (canceled)

22. (canceled)
